(19) United States
(12) Patent Application Publication
(10) Pub. No.: US 2006/0159860 A1
(43) Pub. Date: Jul. 20, 2006

(54) Plasma treated metallized film

(76) Inventor: Robert T. Korowicki, Wayne, NJ (US)

Correspondence Address: LAW OFFICE OF MORRIS E. COHEN, 1122 CONEY ISLAND AVENUE, SUITE 217, BROOKLYN, NY, 11230, US

(21) Appl. No.: 10/524,924

(22) PCT Filed: Aug. 14, 2003
(86) PCT No.: PCT/US03/25582

§ 371 Date: Feb. 17, 2005

Related U.S. Application Data
(60) Provisional application No. 60/448,859, filed on Feb. 21, 2003.
(60) Provisional application No. 60/403,294, filed on Aug. 13, 2002.

(51) Int. Cl. B05D 3/00; B05D 1/36

(52) U.S. Cl. 427/532; 427/402

(57) ABSTRACT

A plasma treated metallized plastic film is provided with super high barrier properties at substantially low cost.

### RELATED APPLICATIONS

The present application claims the priority of U.S. Provisional Application Ser. No. 60/403,294 filed on Aug. 14, 2002, and the priority of U.S. Provisional Application Ser. No. 60/448,859 filed Feb. 21, 2003, both of which are fully incorporated herein by reference.

### FIELD OF THE INVENTION

The present invention relates to metallized films, particularly for use in the food and liquid packaging and decorative balloon industries.

### BACKGROUND OF THE INVENTION

The present invention relates generally to various types of metallized plastic films. Metallized plastic films are known in the art, and are used to provide barriers between the interior and external environment of a package or product. Such barriers can be used, for example, for food and liquid packaging or for decorative balloons. In the case of food and liquid, the barrier provided by the film packaging safeguards the enclosed product against the major causes of loss of food freshness and flavor, namely, oxygen or water vapor flow into the package and/or exposure to ultraviolet light. Similarly, in the case of balloons, the barrier protects against undesirable loss of gas caused by diffusion through the film and out of the balloon, such diffusion resulting in shrinkage and short balloon life.

Various clear plastic films were introduced for use as flexible food packaging in the early sixties. Such clear films, for example, were printed and laminated with polyethylene as an inner layer in the package that is also used for sealability. However, due to the fact that clear plastic film lacks sufficient gas and moisture barrier characteristics needed for proper packaging requirements, metallized film was subsequently introduced in approximately the early seventies. The process of metallization takes place in a vacuum chamber where a metal (e.g. pure aluminum), is melted, evaporated and deposited onto the film's surface. In the case of aluminum, for example, the vapor is deposited on the substrate surface leaving a very thin coat of aluminum metal (e.g. 10-1000 Angstroms) that is enough to seal the surface pores of the substrate. The deposited metal improves the barrier properties by preventing the transmission of oxygen and water vapor from the outside environment to the inside of the package, or so forth.

Subsequently, further technology was developed involving modification of the chemical composition of the metallizable surface. These surface polymer modifications enhance moisture and gas barriers in addition to improving metal adhesion, and are atmospheric treatments (including corona, flame, chemical, and plasma treatment), which result in direct oxidation of the web surface. Most of the surface treatments are designed to modify the top surface of the polymer composition and not to penetrate into the bulk of the material. The greatest care must be exercised to determine which method of surface modification is best for each type film to meet the final required properties of the product.

The various surface treatments have two major disadvantages, however. First, the treatment values are found to decrease with time from the moment that treatment of the surface is complete to the time of metallization in the vacuum chamber. As the rolls are stored in the wound form, the surface energy will decrease due to the diffusion of some chemical groups into the surface of the film. In addition, the additional processes involved in the surface treatment add to the final price of the film.

Accordingly, it would be advantageous in the art to provide an improved treatment method and an improved metallized product which is simple and inexpensive to manufacture, and which provides increased barrier properties. It would be further advantageous to provide a method which can be employed on plain film, and which provides the advantage of the various surface treatments, without dissipation, and at lower cost.

### SUMMARY OF THE INVENTION

It is an object of the present invention to provide a packaging film that is capable of providing enhanced barrier properties to oxygen and water vapor transmission.

It is an object of the present invention to provide a packaging film that is capable of providing enhanced barrier properties to ultraviolet light.

It is a further object of the present invention to provide packaging film with improved barrier properties which is simple and inexpensive to manufacture.

In accordance with the the present invention, a plasma metallized film is provided, particularly for the food and liquid packaging and balloon industries, wherein the film is provided with improved barrier characteristics over prior films in the art while being simple and inexpensive to manufacture. In one preferred embodiment, a method is provided in which a plastic film is subjected to plasma treatment inside the vacuum chamber of a metallization apparatus and is coated on one or both surfaces of the treated film with a desired coating material (e.g. aluminum vapor). Further to the process and reaction conditions disclosed herein, a film is produced exhibiting excellent oxygen and moisture barrier properties. Due to these increased barrier properties, shelf life and the floating time can be extended dramatically while maintaining the aesthetic appeal of the metallized film, a strong advantage in merchandising food and decorative balloon products.

### DETAILED DESCRIPTION OF THE INVENTION

In accordance with the present invention, a method is provided for providing a film having improved barrier properties. In particular, the film provides an improved barrier to oxygen and water vapor transmission, and to ultraviolet light. Further in accordance with the invention, an improved barrier is provided, while providing a method which is simple to implement and resulting in a film which is relatively inexpensive to manufacture. In preferred embodiments, the film can be used in the food and liquid packaging industries, or for decorative balloons.

In accordance with the method of the invention, a user will generally begin with plastic in roll form, with the thickness, width and length of the sheet of plastic on the roll varying according to the user's ultimate needs. For example, the initial film can be of polyester, polypropylene, polyethylene, polyvinyl chloride or nylon. For processing of the initial film into a desired treated form, the film is processed in a vacuum system machine which is used to deposit the coating material onto the film. In a preferred embodiment of the invention, the apparatus used for metallization of the film is a Galileo Vacuum System machine, and further preferably a Galileo Mega2 Model, such as the Mega 4-2410B. However, while the present invention will be described herein with respect to use of the latter machine as an illustration of a preferred embodiment, it will be understood that the present invention is not intended to be limited to such a machine or to the preferred embodiments disclosed herein, as other vacuum metallization machines can be used as well.

In a vacuum system metallization apparatus, various components are provided for processing and metallization of the film, including, for example, the winding system, the vacuum chamber, the pumping system, controls, evaporation system, etc. The rolls of plastic are fed through the winding system portion of the machine, which includes the drive system, the tension control, and so forth. The vacuum chamber is the portion of the machine where a vacuum is produced for use during the coating process, and which has the evaporators for evaporation of the coating material into a gas for deposition onto the film. Pumping of gas within the machine is accomplished by the pumping equipment.

The roll of film is set up inside of the metallization machine on a section referred to as “the unwind shaft”, where the film is unwound off of the roll for passage through the remainder of the machine. From the unwind shaft, the film is threaded through the machine for it to eventually pass through the plasma treater over some additional rollers and through the evaporation zone until it reaches the empty core of the rewind shaft (the rewind station). This process begins with setup of the clear roll in the winding system section. After the setup is complete, the machine is dosed and hermetically sealed for commencement of the pumping down process. During pumping down, all air and gases are removed from the vacuum chamber until reaching a desired high state of vacuum (preferably in the 10⁻⁵ mbar range, and 7.0×10⁻⁵ mbar, for example, in a preferred embodiment).

Once the machine has reached vacuum pressure, plasma treatment can be conducted. As discussed above, plasma treatment involves modification of the surface of the plastic film, and is used to promotes adhesion of the coating material (e.g. a metal) to the film's surface. In addition, plasma treatment can enhance the moisture and gas barrier properties of the resulting metallized film. Within the plasma treater, high voltage power (preferably 7-25 KW), a high magnetic field and a gas mixture are provided. Preferred operating conditions for producing desired metallized films in accordance with the present invention, in conjunction with various film materials, are provided in Table 1 below.

The essential feature of the plasma treatment is that it supplies high-energy electrons in sufficient quantities to generate heavy ions, with electrons being added from the gas blend for bombardment of the film surface. In accordance with the invention, a preferred gas blend for use in the plasma treatment is a mixture of 80% Nitrogen and 20% Argon (“Gas B” of Table 1, also referred to as “Plasma B”). Alternatively, a gas blend of 30% Oxygen and 70% Argon, or 50% Oxygen and 50% Argon can be used. Further alternatively, one or more of the gases Argon, Nitrogen and/or Oxygen can be used, whether individually as pure gases or as a mixture in any combination suitable for the desired application. Or, other gases may be used for treatment of the film surface providing that they are suitable to provide the desired final characteristics of the film achieved herein.

When the plasma generator is in use, ions and electrons are constrained in the magnetic field above the generator where the film is passed through. Also, some systems can be magnetically enhanced to open the field lines toward the film by placing permanent magnets behind the film as it passes through the treater. Those permanent magnets have the effect of directing the ions and electrons toward the film surface.

The electrical system in conjunction with the gas blend fed into the plasma treater will clean and activate the film surface for chemical modification. This change in the surface characteristics occurs just prior to the deposition of the coating material (e.g. aluminum vapor). It is believed that oxygen species are generated on the film surface under the metal layer resulting in oxidized surfaces. That oxygen is either added to the surface by the gas or is drawn to the surface from the polymer itself.

The plasma treater is provided in an area within the machine which is located before the evaporation zone, and which is sealed from the evaporation zone. After passing through the plasma treater, the film is moved into that evaporation zone. Isolation of the plasma treater from the evaporation zone is provided so that the gas from the plasma treater will not interfere with the evaporation process.

After treatment of the film with the plasma treater, the plasma treated film moves into and through the evaporation zone, where the evaporators melt and evaporate the coating component to be applied to the film. In the evaporation zone, solid coating material is fed into the evaporators (e.g. aluminum wire or any other desired coating material), and as the evaporators heat up to reach the desired temperature (e.g. 1400 degrees centigrade in the case of aluminum) the coating material is vaporized.

Although the process of the present invention can be conducted at any desired rate, in a preferred embodiment the machine is simultaneously activated to pump out gas to reach the desired vacuum pressure, while power is provided to the plasma treaters and the evaporators are heated to the necessary temperature, before beginning to move the film within the machine. This allows the film to be rapidly and efficiently moved through the entire machine from section to section once the various sections of the machine are ready, without needing to wait in one section for a subsequent section to be available for use. Generally, it is necessary to wait several minutes until the coating material has been fed into all of the evaporators (also known as “boats”), and until that material has filled all of the pores in the ceramic and begun to vaporize uniformly before beginning a run of film through the metallization machine. In other words, preferably the evaporators are warmed up and all of the boats in the line are stabilized prior to initiating treatment of the film with the plasma treater, so that the film can pass from the plasma treater into the evaporation zone and onward without delay.

Thus, it is in the evaporation zone that the plasma treated film comes into contact with the coating material. The temperatures for the evaporators depend on the material to be evaporated. In a preferred embodiment, pure aluminum is evaporated for deposit on the film, e.g. at temperatures beginning from approximately 1400 degrees Centigrade (1400° C.). In alternative embodiments, silver or gold or tin or other metals, or glass (as a silica) could be utilized. Accordingly, while aluminum is generally referred to in the illustrations herein as an example of a preferred embodiment, it is to be understood that the present invention is not limited to such preferred material.

In the evaporation step, coating material molecules travel throughout the evaporation zone in a vacuum. To produce the desired vacuum, pumping equipment is provided in communication with the evaporation zone to improve the coating process within that zone. For example, in the case of aluminum, it is important that the aluminum not come into contact with any oxygen molecules, since pure aluminum is to be deposited on the film, with the presence of any aluminum oxide being highly undesirable. Similarly, aluminum can boil and evaporate more efficiently at the lower pressure. The vacuum also facilitates the free travel of the aluminum molecules to provide an even coat from one edge to another of the film, such that dark and light areas are not produced on the film. In addition, the pumping out of oxygen helps avoid damage to the ceramic evaporators, since the presence of oxygen molecules around those high temperature evaporators (running at approximately 1400° C. or higher) will degrade the evaporators and decrease their effective life.

Within the vacuum, the aluminum comes into contact with the surface of the plastic film, which may pass over a chill roller. The chill roller is a roller maintained at a sufficiently low temperature to maintain the dimensional stability of the plastic film when it is exposed to the excessive heat of the vapor, and further preferably to maintain the film at a sufficiently low temperature to promote condensation of the aluminum thereon. For example, while the vapor may be approximately 1400° C., the film may be approximately 70-80 degrees Fahrenheit.

Although a chill roller is needed for those films which are very sensitive to heat, a chill roller is not essential for the process. Some films resist heat and therefore do not need special cooling. With those films, the ambient temperature of the film or the cold temperature of vacuum can itself provide a sufficient temperature difference to cause condensation, and the movement of the film at a rapid line speed results in insufficent time for the film to melt. Likewise, the film does not need to be supported by the chill roller during the evaporation, but rather can be free spanning, i.e. metallized while running between two rollers. When the film is free spanning, it can be cooled after the evaporation step, if desired, using a chill roller or by a cooling tower.

When the coating material vapor comes into contact with the film on the roller it condenses on the film's surface. Upon contact, both a chemical bonding and physical bonding occurs between the aluminum and the film. A coat of material is thereby provided on the substrate in the sufficient thickness to seal the surface pores of the substrate. In the preferred embodiment, a coating of, for example, 120-200 or more preferably, 10-1000 Angstroms is used, although any other desired thickness may be employed if desired. For example, a greater coating thickness may be used in the embodiments utilizing multiple coating layers on one or both sides of the film to further reduce transmission through the material, i.e. to increase the barrier properties, albeit at higher cost.

After deposition of the aluminum on the film, the film is rewound on the empty core, producing the finished roll. After the roll is complete, the pumping valves are closed, power is turned off of the evaporators, and an inlet air valve is opened to put more air into the machine to reach atmospheric pressure. At that point, the machine is opened and the finished roll can be removed.

Generally, the amount of improvement in the barrier properties and metal adhesion depends on the reaction conditions, including, for example, the gas in use, the blend ratio and the flow rate. Thus, in accordance with the present invention, reaction conditions have been developed which optimize the barrier properties produced in accordance with the invention. The preferred reaction conditions for producing improved metallized films with various film types in accordance with the invention, are shown in Table 1 as follows:

TABLE 1
Reaction Conditions for Plasma Metallization Process

| | | | | Flow/s | | Line speed | Drum | | Optical |
|---|---|---|---|---|---|---|---|---|---|
| Film type | Gauge | MOS/MBS | Gas | cm3/s | Power | ft/M | temp. | Vacuum | Density |
| Nylon | 40 | MOS | B | 500 | 10 KW | 1400 | −4 F. | 7.0E−005 | 2.6 |
| | | | | | | | | mbar | |
| Nylon | 48 | MOS | B | 500 | 10 KW | 1400 | −4 F. | 7.0E−005 | 2.6 |
| | | | | | | | | mbar | |
| Nylon | 40 | Mbar S | B | 500 | 10 KW | 1400 | −4 F. | 7.0E−005 | 3.7 |
| | | | | | | | | mbar | |
| PET/Plain | 48 | MOS | B | 500 | 12 KW | 1850 | −4 F. | 7.0E−005 | 2.2 |
| | | | | | | | | mbar | |
| PET/Chem. | 48 | MOS | B | 500 | 12 KW | 1975 | −4 F. | 7.0E−005 | 2 |
| | | | | | | | | mbar | |
| PET/Chem. | 48 | MOS | B | 500 | 12 KW | 1100 | −4 F. | 7.0E−005 | 3 |
| | | | | | | | | mbar | |
| OPP | 70 | MOS | B | 500 | 12 KW | 1100 | −4 F. | 7.0E−005 | 3 |
| | | | | | | | | mbar | |

Accordingly, further to the invention, a highly effective film is produced at decreased cost. In general, a saving of at least 15% can be achieved by metallizing a plain film with the plasma treatment methods of the present invention rather than using a film with a special formulation. Tables 2 and 3 below, for example, shows a comparison of some common values that can be produced using the present invention, followed by some typical values for barrier properties of past metallized and clear products at 0.5 mil:

TABLE 2
Oxygen transmission rate (OTR) (reported in
cc/100 in²/day at 75° F. and 50% RH)

| Plasma treated and metallized on both sides | .0035 or less |
|---|---|
| (in accordance with the present invention) | |
| Plasma treated metallized on one side | .01-.025 |
| (in accordance with the present invention) | |
| Metallized PET film | .05-.08 |
| Metallized OPP | .06-1.0 |
| Clear PET film | 7-9 |
| Clear OPP | 95-130 |
| Clear Nylon | 2-3.8 |

TABLE 3
Water vapor transmission rate (WVTR) (reported
in gr/100 in²/day @ 100° F. 100% RH)

| | |
|---|---|
| Plasma treated and metallized on one side | .008-.015 |
| (in accordance with the present invention) | |
| Metallized PET film | .05-.1 |
| Clear PET film | 2.8 |
| Clear OPP film | .5-1.0 |
| Clear Nylon | 7-11 |

In a further preferred embodiment of the invention, a three-zone geometry is used (as is available, for example, in the Galileo Mega2). In this embodiment, in-line surface treatment (i.e. plasma treatment within the metallization machine) takes place in the first zone. This allows the surface of the film to be cleaned of imperfections and impurities and prepared for better metal adhesion, and thus, improved barrier performance, all in-line. Metallizing takes place in a second vacuum zone, and can be conducted at a line speed as fast as 3,000 fpm. Due to the multi-zone geometry, the machine can achieve and maintain a vacuum in the 10⁻⁵ mbar range, which improves metal density and prevents spit holes. Furthermore, the Mega 2 machines can deposit aluminum for microwave applications as well as for complete opacity. The web is cooled in the third vacuum zone, where it is possible to maintain the web's temperature within two degrees, even at a high level of metal deposition. This cooling system allows running of plastic films that are heat sensitive and extensible. Furthermore, as a result of the three-zone system, a different vacuum level can be maintained in each of the three zones if desired. For example, a higher degree of vacuum can be maintained in the evaporation zone than in the winding zone, where as high a level of vacuum is not necessary.

Further factors which can be used to modify the barrier characteristics of the film, include adjustment of the process to conduct plasma treatment and metallization on one or both sides of the film or both (“Surface A” and/or “Surface B”) and/or to conduct one or more passes on each side. Thus, while exemplary results can be obtained using just one pass at metallization, further passes of metallization can be used to increase the barrier properties resulting, albeit at higher cost.

In one such series of embodiments, for example, one side of the substrate film can be metallized (“Metal One Side” or “MOS” of Table 1), with the film plasma treated on one or or both sides of the film (surface A or B). For example, the substrate film can be plasma treated on a surface of the film (surface A or B) and metallized on that plasma treated side in one pass. Or, the substrate film can be plasma treated on surface A or B, and then metallized on that plasma treated surface, and then remetallized again on that metal side (two pass). Or, the substrate film can be metallized on surface A or B (before any plasma treatment), then plasma treated on that metallized side, then remetallized again on that plasma treated metal surface (two pass). Or, the substrate film can be plasma treated on surface A or B, and then metallized on the plasma treated surface, then plasma treated again on that metallized side, and remetallized again on the plasma treated metallized surface (two pass).

In a further series of embodiments, both sides of the substrate film can be metallized (“Metal Both Sides” or “MBS” of Table 1). For example, the substrate film can be plasma treated on both surfaces A & B, and then metallized once on each surface (one pass each side). Or, the substrate film can be plasma treated only on one surface (surface A or B) and metallized on both surfaces (one pass each side). Or, the substrate film can be plasma treated on both surfaces A & B, with side A and side B each metallized once, then plasma treated again on one side, and remetallized for a second time on that same side (one pass side A and two pass side B). Or, the substrate film can be metallized on both surfaces A & B (before any plasma treatment), then surface A or surface B can be plasma treated, followed by remetallization for a second time over that plasma treated side (one side one pass, the second side two pass). Or, the substrate film can have surface A just metallized and surface B both plasma treated and metallized, followed by surface B being plasma treated again and remetallized for a second time (one pass surface A and two pass surface B). Or, the substrate film can have surface A both plasma treated and metallized, and surface B initially just metallized, followed by surface B being plasma treated (on that metallized surface) and then remetallized for a second time (one pass surface A and two pass surface B).

Similarly, any further number or combination of plasma treatments and/or metallizations on either or both sides of the film can be conducted consistent with the present invention.

Accordingly, in accordance with the invention, a super high barrier plasma treated plastic film (e.g. polyester, polypropylene, polyethylene, polyvinyl chloride or nylon) is provided that is metallized on one or both surfaces of the film, and which can be used, for example, for food or liquid packaging or for decorative balloons, at low cost. The oxygen transmission rate (OTR) through the treated film achieved via the invention is less than 0.01 cc/100 in²/day and the water vapor transmission rate (WVTR) is reduced to 0.02-0.35 or even to less than 0.02 gr/100 in²/day at 100° F./100% RH, depending on the selected substrate.

For example, with nylon the oxygen transmission rate (OTR) is reduced from 0.07 cc/100 in²/day with prior art methods to 0.015 cc/100 in²/day. For nylon MBS, the OTR is reduced from 0.070 cc/100 in²/day to 0.0025 cc/100 in²/day. For polyester, the OTR is reduced from 0.050-0.070 to a range of 0.015-0.030 cc/100 in²/day. The water vapor transmission rate (WVTR) also was reduced from 0.070-0.100 gr/100 in²/day at 100° F. and 100% RH to 0.020-0.035 gr/100 in²/day. For example, with OPP WVTR was reduced from the normal 0.050 gr/100 in²/day to as low as 0.015 gr/100 in²/day at 100° F. and 100% RH. The metal adhesion bond was also increased using the invention from 250 gr/in to 400-500 gr/in.

Furthermore, the choice of using one or two sides for metallization and/or plasma treatment, and of conducting plasma and/or metallization treatment one time or multiple times (whether twice, three times or more), can be made to yet further increase the barrier properties of the invention to whatever extent desired. Such variations are highly effective, albeit at increased cost. Accordingly, while the barrier properties listed above are typical values produced at relatively inexpensive cost, an even more impermeable barrier can nonetheless be achieved, if desired, in accordance with the invention.

The metallized film preferably has a thickness in the range of 0.20 mil to 10 mil where the thickness is chosen depending on the desired stiffness of the package needed for the final product. In one of the preferred embodiments, that metallized film is further comprised of plain plastic film, the film being plasma treated on one or both surfaces and metallized on one or both surfaces of the film. Also, the substrate surface of the film may be chemically or corona treated prior to plasma treatment or metallization, using known methods. For example, chemically treated SP91 film or SP95 film can be utilized, as available from SKC Materials, Inc. of Covington, Ga. The gases used for the plasma treatment can be Argon, Nitrogen and/or Oxygen at various ratios, or other desired gases.

Having described this invention with regard to specific embodiments, it is to be understood that the description is not meant as a limitation since further modifications may suggest themselves, or may be apparent to those in the art. It is intended that the present application cover all such modifications and improvements thereon.

1-80. (canceled)

81. A method comprising the steps of:
providing a material for use in food or liquid packaging, said material comprising a plastic film, said plastic film having been subjected to plasma treatment inside the vacuum chamber of a metallization apparatus, said plastic film having been coated on at least one side with a desired metal to form a metallized plastic film, said metallized plastic film comprising an oxygen transmission rate (OTR) of no greater than 0.03 cc/100 in²/day, and a water vapor transmission rate of no greater than 0.035 gr/100 in²/day at 100° F. and 100% relative humidity (RH), and wherein said plasma treatment uses a mixture of at least two gases selected from the group comprising: Nitrogen, Argon, and Oxygen.

82. A method as claimed in claim 81, wherein said metal is aluminum.

83. A method as claimed in claim 81, wherein said metal is silver.

84. A method as claimed in claim 81, wherein said metal is gold.

85. A method as claimed in claim 81, wherein said metal is tin.

86. A method as claimed in claim 81, wherein said plastic film comprises polyester.

87. A method as claimed in claim 81, wherein said plastic film comprises polypropylene.

88. A method as claimed in claim 81, wherein said plastic film comprises polyethylene.

89. A method as claimed in claim 81, wherein said plastic film comprises polyvinyl chloride.

90. A method as claimed in claim 81, wherein said plastic film comprises nylon.

91. A method as claimed in claim 81, wherein said plasma treatment uses a mixture of Nitrogen and Oxygen.

92. A method as claimed in claim 81, wherein said plasma treatment uses a mixture of Nitrogen and Argon.

93. A method as claimed in claim 81, wherein said plasma treatment uses a mixture of 80% Nitrogen and 20% Argon.

94. A method as claimed in claim 81, wherein said plasma treatment uses a mixture of Oxygen and Argon.

95. A method as claimed in claim 81, wherein said plasma treatment uses a mixture of 30% Oxygen and 70% Argon.

96. A method as claimed in claim 81, wherein said plasma treatment uses a mixture of 50% Oxygen and 50% Argon.

97. A method as claimed in claim 81, wherein said oxygen transmission rate is between 0.01 and 0.03 cc/100 in²/day.

98. A method as claimed in claim 81, wherein said oxygen transmission rate is no greater than 0.010 cc/100 in²/day.

99. A method as claimed in claim 81, wherein said oxygen transmission rate is no greater than 0.0035 cc/100 in²/day.

100. A method as claimed in claim 81, wherein said oxygen transmission rate is no greater than 0.0025 cc/100 in²/day.

101. A method as claimed in claim 81, wherein said water vapor transmission rate is between 0.02-0.035 gr/100 in²/day at 100° F. and 100% RH.

102. A method as claimed in claims 1, wherein said water vapor transmission rate is no greater than 0.02 gr/100 in²/day at 100° F. and 100% RH.

103. A method as claimed in claim 81, wherein said water vapor transmission rate is no greater than 0.015 gr/100 in²/day at 100° F. and 100% RH.

104. A method as claimed in claim 81, wherein said plastic film has been metallized on one side of said plastic film.

105. A method as claimed in claim 81, wherein said plastic film has been metallized on both sides of said plastic film.

106. A method as claimed in claim 81, wherein said plastic film has been plasma treated on one side of said plastic film.

107. A method as claimed in claim 81, wherein said plastic film has been plasma treated on both sides of said plastic film.

108. A method as claimed in claim 81, wherein said plastic film has been metallized at least twice on at least one side of said plastic film.

109. A method as claimed in claim 81, wherein said plastic film has been plasma treated at least twice on at least one side of said plastic film.

110. A method as claimed in claim 81, wherein said plastic film has been metallized at least twice and plasma treated at least twice.

111. A method as claimed in claim 81, wherein said plastic film has been plasma treated on a first side of said plastic film and has been metallized on said first side.

112. A method as claimed in claim 81, wherein said plastic film has been plasma treated on a first side of said plastic film, followed by metallization on said first side, followed by metallization again on said first side.

113. A method as claimed in claim 81, wherein said plastic film has been metallized on a first side of said plastic film, followed by plasma treatment on said first side, followed by metallization again on said first side.

114. A method as claimed in claim 81, wherein said plastic film has been plasma treated on a first side of said plastic film, then metallized on said first side, then plasma treated again on said first side, then metallized again on said first side.

115. A method as claimed in claim 81, wherein said plastic film has been plasma treated on both sides of said plastic film and metallized on both sides of said plastic film.

116. A method as claimed in claim 81, wherein said plastic film has been plasma treated on a first side of said plastic film, and has been metallized on both sides of said plastic film.

117. A method as claimed in claim 81, wherein said plastic film has been plasma treated and metallized on a first side and a second side of said plastic film such plasma treatment and metallization being conducted once in any order, followed by plasma treatment again on said first side, followed by metallization again on said first side.

118. A method as claimed in claim 81, wherein said plastic film has been metallized on both a first side and a second side of said plastic film, followed by plasma treatment on said first side, followed by metallization again on said first side.

119. A method as claimed in claim 81, wherein said plastic film has been metallized on a first side of said plastic film and both metallized and plasma treated on a second side of said plastic film, followed by a second plasma treatment and second metallization on said second side, said second plasma treatment and second metallization being conducted in either order.

120. A method as claimed in claim 81, wherein said plastic film has been both plasma treated and metallized on a first side of said plastic film, and metallized on a second side of said plastic film, followed by plasma treatement on said second side, and metallization again on said second side.
